(19) United States
(12) Patent Application Publication
(10) Pub. No.: US 2025/0003632 A1
(43) Pub. Date: Jan. 2, 2025

(54) FLOW HEATER

(71) Applicant: BorgWarner Inc., Auburn Hills, MI (US)

(72) Inventors: Hai Yuan, Zhejiang (CN); Qi Chen, Zhejiang (CN); Lijun Zhuo, Zhejiang (CN); Feiliang Xu, Zhejiang (CN)

(21) Appl. No.: 18/754,217

(22) Filed: Jun. 26, 2024

(30) Foreign Application Priority Data
Jun. 28, 2023 (EP) 23182123.2

(51) Int. Cl. F24H 1/10; F24H 9/00

(52) U.S. Cl. CPC F24H 1/102; F24H 9/0015

(57) ABSTRACT

Disclosed is a flow heater comprising housing in which a flow channel for liquid to be heated extends from an inlet to an outlet, and a casing arranged inside the housing, and a heating resistor arranged inside the casing. The heating resistor is a wire embedded in insulating material.

### CROSS REFERENCE TO RELATED APPLICATIONS

This application claims the priority to European Patent Application No. EP23182123.2 filed on Jun. 28, 2023, and the entire content of this priority application is incorporated herein by reference in its entirety.

### TECHNICAL FIELD

The disclosure refers to a flow heater for heating liquids. A flow heater with the characteristics listed in the preamble of claim 1 is disclosed in U.S. Pat. No. 8,731,386.

### BACKGROUND

A constant goal in the design of flow heaters for heating liquids is to provide a compact and cost-efficient flow heater. An object of at least some implementations of the present disclosure is to provide a more compact, more robust and cost-efficient flow heater.

This object is solved by a flow heater. Advantageous refinements of the disclosure are the matter of dependent claims.

### SUMMARY

In a flow heater according to the present disclosure, the heating resistor is a wire embedded in insulating material inside a casing that is arranged in a housing in which a flow channel for liquid to be heated extends from an inlet to an outlet. In this way the casing with a heating resistor can cost-efficiently be manufactured as a separate assembly that is then arranged in the housing of the flow heater. Moreover, wire embedded in insulating material can withstand high operating temperatures such that liquid can be quickly heated in a compact flow heater. The wire used as a heating resistor may be made of a nickel-based alloy, e.g. a nickel chromium alloy, for example. The insulator in which the wire is embedded inside the casing may be a ceramic power, e.g. magnesium oxide.

In an advantageous refinement of the disclosure the casing may be provided with fins that are arranged inside the flow channel. Thereby heat can be more efficiently transferred to liquid inside the flow channel and the heating device can be made more compact and more robust. Fins may for example be brazed or welded to an outer surface of the casing. Fins can significantly reduce the surface temperature of the casing and thereby make heat transfer more efficient.

In a further advantageous refinement of the disclosure, the casing is arranged inside the flow channel such that the flow channel branches into a first part and a second part that flow along opposite sides of the casing. In this way the transfer of heat from the casing to liquid can be improved. Fins may then be provided on both sides of the casing.

In a further advantageous refinement of the disclosure, the casing is strip-shaped or plate-shaped. For example, the casing may be a flat cuboid or oval shape. Such a casing has two opposing broad or major sides that are connected by narrow, smaller sides. Fins may be provided on the broad sides. Such a casing may be produced cost-efficiently by folding a sheet of metal into a flat tube. Edges of the sheet that are brought together by folding of the sheet may be connected by welding. End sections of such a casing may then be closed with separate closure elements.

In a further advantageous refinement of the disclosure, the housing is strip-shaped or plate-shaped. That is the thickness of the housing is less than the width and length of the housing, e.g. not more than one fifth of the width and not more than one fifth of the length of the housing. Such a housing has two opposing broad or major sides that are connected by narrow, smaller sides. The inlet and the outlet may be provided in a narrow side, which may be in the same narrow side.

In a flow heater with a strip-shaped or plate-shaped housing, the flow channel may have a first end section, which is adjacent to the inlet and arranged between a first narrow side of the housing and the casing, and a second end section, which is arranged adjacent to the outlet and arranged between a second narrow side of the housing and the casing. The first narrow side of the housing is opposite of the second narrow side. In such an embodiment, the end sections may have a width that increases towards the inlet and the outlet, respectively. Thereby flow of liquid to be heated through the housing can be optimized and heat transfer improved. Further optimization of the housing may be made to have a more homogeneous coolant distribution and improved coolant velocity in order to reduce casing surface temperature and improve heating device robustness.

### BRIEF DESCRIPTION OF THE DRAWINGS

Further details and advantages of the disclosure are explained in the following in connection with reference to the attached drawings. In the various drawings, equal and corresponding parts are provided with identical reference numerals.

FIG. 1 shows a top view of a flow heater comprising an outer housing;

FIG. 2 shows a bottom view of the flow heater of FIG. 1;

FIG. 3 shows a top view of the flow heater of FIG. 1 without cover;

FIG. 4 shows a top view of the flow heater of FIG. 3 without circuit board;

FIG. 5 shows the flow heater of FIG. 1 without outer housing and circuit board;

FIG. 6 shows an exploded view of FIG. 5 without baffles;

FIG. 7 shows schematically a detail of the flow heater; and

FIG. 8 shows schematically stages of the production of a casing for the flow heater.

### DETAILED DESCRIPTION

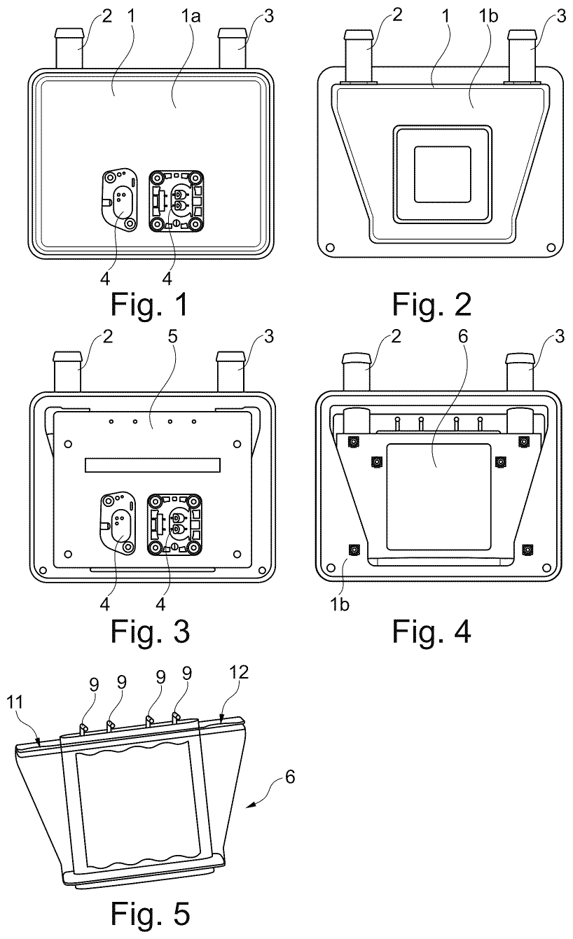

FIGS. 1 and 2 show a top and bottom view, respectively, of a flow heater comprising an outer housing 1 with an inlet spigot 2 and an outlet spigot 3 as well as electrical connectors 4. The outer housing 1 may be a two-part housing comprising a cover part la and a bottom part 1b, for example. The flow heater may be adapted to be used in an automobile for heating liquids, for example.

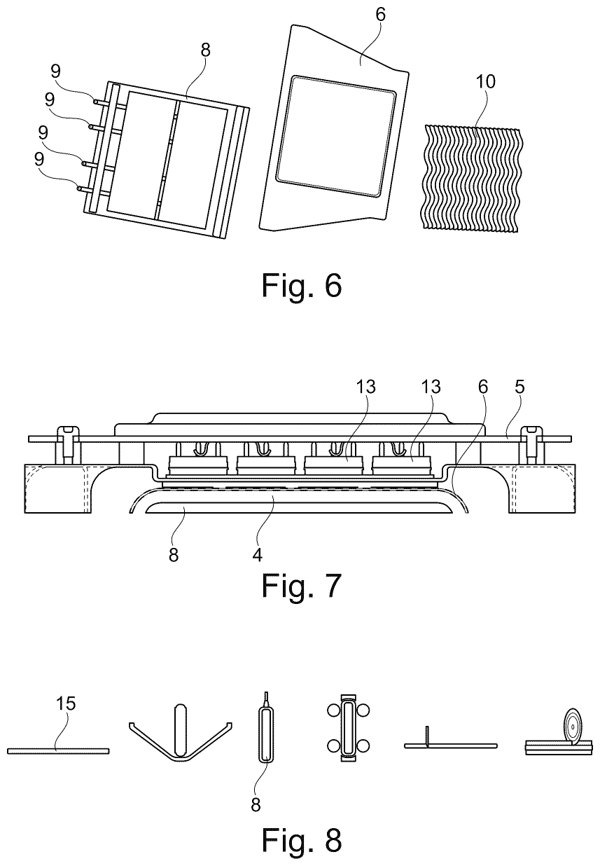

FIG. 3 shows a top view of this flow heater without the cover part. In this view a circuit board 5 is visible to which electrical connectors 4 are connected. In FIG. 4, the circuit board is removed such that a housing 6 is visible to which the inlet spigot 2 and the outlet spigot 3 are connected and through which liquid to be heated flows. This housing 6 through which liquid to be heated flows is shown schematically in a semi-transparent fashion in FIG. 5. FIG. 6 shows an exploded view of the housing 6 shown in FIG. 5.

Inside the housing 6 is a casing 8 in which a heating resistor in the form of wire is arranged. The wire may made of a nickel based alloy, e.g. a nickel chromium alloy. The wire may be wound on a molded insulator and embedded in ceramic power like magnesium oxide. Such insulator powder may fill space between heating wire and casing. In the casing shown in FIG. 6, two or more wires may be arranged as heating resistors. Terminals 9 of these wires protrude from the casing 8 and are connected to the circuit board 5 shown in FIG. 3.

The casing 8 is plate-shaped or strip-shaped and may be a flat cuboid or oval shape, for example. It has two opposing broad or major sides that are connected by narrow, smaller sides. In FIG. 6, the casing 8 is shown in a view towards one of the broad or major sides. Both broad sides may be provided with fins 10 that may be welded or brazed to the casing 8. The housing 6 may also be plate-shaped and thus also have two opposing broad or major sides that are connected by narrow, smaller sides.

The housing 6 has an inlet 11 and an outlet 12 that are connected to the inlet spigot 2 or the outlet spigot 3, respectively. A flow channel for liquid to be heated extends inside the housing 6 from the inlet 11 to the outlet 12. In the embodiment shown, both the inlet 11 and the outlet 12 are arranged in the same narrow front side of the housing 8, but the inlet and/or the outlet may also be arranged at a different place.

The flow channel inside the housing 6 has two end sections. One of these end sections is adjacent to the inlet 11, the other to the outlet 12. Between these end sections is the casing 8. The flow channel branches at the end section adjacent to the inlet 11 into a first part which is arranged between a first housing wall and a first surface of the casing 8, and a second part, which is arranged between a second housing wall and a second surface of the casing 8, wherein the second surface of the casing 8 is opposite to the first surface of the casing 8. Thus in the perspective shown in FIG. 5 part of the liquid to be heated flows behind the casing 8 between the casing 8 and a rear wall of the housing 6 and another part flows in front of the casing 8 between the housing's front wall shown in FIG. 5 and the casing 8.

As shown in FIG. 5, the flow channel's end sections to the left and to the right of the casing 6 are tapering in a direction away from the inlet 11 or the out 12, respectively. Hence, a distance from a narrow side of the casing 8 to an adjacent inner surface of the housing 6 decreases with increasing distance from the inlet 11 or the outlet 12, respectively. Starting from the inlet 11 the amount of liquid to be heated in the end section to the left of the casing 8 decreases with increasing distance from the inlet 11 as more and more liquid flows into the gap between the fin bearing broad sides of the casing 8 and the adjacent housing wall. Correspondingly, there is the more liquid in the end section on the right side of the casing 8 the closer to the outlet 12. Thus, the tapering end sections improve flow of liquid through the housing 6.

FIG. 7 shows schematically a detail of a cross-section of the flow heater without the outer housing. The circuit board 5 carries transistor switches 13 that switch heating power supplied to the heating resistor inside the casing 8. The transistor switches 13 are arranged between the circuit board 5 and the housing 6, i.e. on the side of the circuit board 5 that is facing the housing 6. The transistor switches 13 are thermally connected to the housing 8. Waste heat of the transistor switches 13 is therefore transferred to the casing 6 and to liquid flowing through the casing 6. Fins 10 are arranged between the casing 8 housing 6 and insulating powder 14 fills space around the heating resistor 16 inside the casing 8.

The casing 8 may be made of sheet metal by folding a sheet metal strip into a flat tube and connecting edges of the strip that are brought together by folding. For example, edges of the strip may be connected by welding. FIG. 8 shows schematically how the casing 8 may be produced from sheet metal. A sheet of metal 15 is folded into a flat tube or plate. Edges of the sheet of metal that are thereby brought into contact are then connected, e.g. by welding. One or more wires are then arranged inside the casing 8 and embedded in insulating material. The casing 8 may be formed, e.g. by rolling, and cut to size. After one or more wires and insulating material have been arranged inside the casing 8, both ends of the casing 8 may be closed by means of caps are closure elements.

1. A flow heater comprising:
a housing in which a flow channel for liquid to be heated extends from an inlet to an outlet, and
a casing arranged inside the housing, and
a heating resistor arranged inside the casing,
wherein the heating resistor is wire embedded in insulating material.

2. The heater according to claim 1, wherein the casing is provided with fins arranged in the flow channel.

3. The flow heater according to claim 2, wherein the fins are brazed or welded to the casing.

4. The flow heater according to claim 1, wherein the flow channel branches into a first part, which is arranged between a first housing wall and a first surface of the casing, and a second part, which is arranged between a second housing wall and a second surface of the casing, wherein the second surface of the casing is opposite to the first surface of the casing.

5. The flow heater according to claim 4, wherein fins are arranged on the both the first surface of the casing and on the second surface of the casing.

6. The flow heater according to claim 1, wherein the casing is plate-shaped or strip shaped.

7. The flow heater according to claim 6, wherein the casing is made of a strip of sheet metal folded into a plate or flat tube.

8. The flow heater according to claim 1, wherein the housing is a plate-shaped or strip-shaped housing with opposing broad sides and narrow sides connecting the broad sides, wherein the flow channel has a first end section, which is adjacent to the inlet and arranged between a first narrow side of the housing and the casing, and a second end section, which is arranged adjacent to the outlet and arranged between a second narrow side of the housing and the casing, wherein the first narrow side of the housing is opposite of the second narrow side.

9. The flow heater according to claim 8, wherein the end sections have a width that increases towards the inlet and the outlet, respectively.

10. The flow heater according to claim 8, wherein the inlet and the outlet are arranged on the same side of the housing, and wherein has a width that is measured from the first narrow side to the second narrow side and increases towards the inlet and the outlet.

11. The flow heater according to claim 1, wherein wire terminals are connected to a circuit board that is arranged on a flat side of the housing.

12. The flow heater according to claim 11, wherein transistor switches are arranged on the circuit board, wherein the transistor switches are arranged on a side of the circuit board facing the housing and thermally connected to the housing.

13. The flow heater according to claim 11, comprising an outer housing in which the housing and the circuit board are arranged.

14. A flow heater comprising:
a housing in which a flow channel for liquid to be heated extends from an inlet to an outlet, and
casing arranged inside the housing, and
heating resistor arranged inside the casing, said heating resistor being wire embedded in insulating material,
wherein the housing is a plate-shaped or strip-shaped housing with opposing broad sides and narrow sides connecting the broad sides, wherein the flow channel has a first end section, which is adjacent to the inlet and arranged between a first narrow side of the housing and the casing, and a second end section, which is arranged adjacent to the outlet and arranged between a second narrow side of the housing and the casing, wherein the first narrow side of the housing is opposite of the second narrow side, and
wherein the end sections have a width that increases towards the inlet and the outlet, respectively.
